(19) United States
(12) Patent Application Publication
(10) Pub. No.: US 2006/0143310 A1
(43) Pub. Date: Jun. 29, 2006

(54) Electronic device, electronic device system and communication method

(75) Inventor: Kazuya Fukushima, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/362,811

(22) Filed: Feb. 28, 2006

Related U.S. Application Data
(63) Continuation of application No. 09/953,889, filed on Sep. 18, 2001.

(30) Foreign Application Priority Data
Sep. 27, 2000 (JP) JP 2000-293642

(51) Int. Cl. G06F 15/16

(52) U.S. Cl. 709/250

(57) ABSTRACT

A personal computer system comprises a notebook type personal computer and an expansion device to which the personal computer is removably docked. The expansion device comprises a wired LAN interface. The personal computer comprises a wireless communication interface, a docking detector, and a device driver communicating with another device by the LAN interface when docking is detected, and by the wireless communication interface when undocking is detected.

### CROSS-REFERENCE TO RELATED APPLICATIONS

This application is based upon and claims the benefit of priority from the prior Japanese Patent Application No. 2000-293624, filed Sep. 27, 2000, the entire contents of which are incorporated herein by reference.

### BACKGROUND OF THE INVENTION

1. Field of the Invention

The present invention relates to an electronic device such as a personal computer, an electronic device system comprising the electronic device and a function expansion device removably connected thereto, and a communication method for executing switching of a communication interface therebetween.

2. Description of the Related Art

In recent years, a notebook type personal computer takes importance of compactness, is miniaturized and light weighted, and has only required minimum functions. Therefore, eliminated functions are provided at a docking station removably connected to the personal computer. The personal computer is connected to the docking station, thereby expanding functions. The docking station provides, for example, a modular jack for connecting a LAN cable, a CD-ROM drive or floppy disk drive, and a connector to be connected to an external CRT display monitor.

In a system comprising such a personal computer and docking station, when a personal computer is used at home or at office, the personal computer and docking station are connected to each other, and are used as a multi-functional electronic device system. When one goes out, one carries only a personal computer main body, and uses the main body as a smaller, light weighted electronic device while maintaining high general-purpose use properties.

In recent years, there has been increased environment for forming a network such as LAN, and transmitting/receiving data to/from another personal computer. As interfaces for making this network connection, there have been practically used various type of interfaces employing a wired cable or interfaces employing wireless or infrared-ray communication and the like. A network connection interface that a docking station has may differ from a network connection interface that a personal computer has. Thus, in the case of making a connection (docking) between the personal computer and docking station and in the case of make disconnection (undocking) between the personal computer and docking station, it is required to switch a network connection interface. That is, when the personal computer is docked with the docking station, the network connection interface that the docking station has is employed; and when the personal computer is undocked from the docking station, the network connection interface that the personal computer has is employed. However, in this case, it is required to set the system configuration during docking and undocking, respectively. In addition, it is required to restart a personal computer every time the system configuration is set, which is a time consumable work.

Switching a network connection interface is disclosed in Japanese Patent KOKAI Publication No. H10-56411. This document describes that, in an information processing device having an infrared-ray communication interface and a wireless communication interface, in the case where a communication state of infrared-ray communication is monitored by a CPU, and an infrared-ray communication state is deteriorated, a hardware switch is switched to a wireless communication. This causes a problem that a burden on a CPU is always applied because the CPU always monitors a communication state. In the case where communication interfaces between an infrared-ray communication and a wireless communication are provided in one device, there is considered a state in which both of these communication interfaces are unusable at the same time. In such a situation, there is a problem that external communication cannot be carried out at all. Further, although this prior art switches a communication interface, such switching is not achieved according to a state of connection between a removable main body and an extension device.

There has been disclosed Japanese Patent KOKAI Publication No. 2000-152331 as another conventional example. This is for switching the communication interfaces according to the connection state between the removable main body and the operation display portion. However, a communication interface to be switched is a communication interface between the main body and the operation display portion. In the case where the main body and the operation display portion are connected to each other, a wired communication via a node is merely selected. In the case where the main body and the operation display portion are not connected to each other, a wireless communication is selected (because a node is not connected). Thus, a communication interface between the main body and an external device is not switched.

### BRIEF SUMMARY OF THE INVENTION

It is an object of the present invention to provide an electronic device, an electronic device system, and a communication method capable of switching communication devices between the electronic device and another device according to a connection/disconnection state of them in a system comprising an electronic device and accessories removably connected to the electronic device.

According to one aspect of the present invention, there is provided an electronic device system comprising an expansion device comprising a first communication device; and an electronic device which is connectable with the expansion device and comprises a second communication device, a detector configured to detect connection with and disconnection from the expansion device, and a communication controller configured to communicate with another device by the first communication device when the detector detects connection with the expansion device, and communicate with another device by the second communication device when the detector detects disconnection from the expansion device.

According to another aspect of the present invention, there is provided an electronic device which is connectable with an expansion device for adding a device which is not provided in the electronic device, the expansion device comprising a first communication device, the electronic device comprising a second communication device; a detector configured to detect connection with and disconnection from the expansion device; and a communication controller configured to communicate with another device by the first communication device when the detector detects connection with the expansion device, and communicate with another device by the second communication device when the detector detects disconnection from the expansion device.

According to still another aspect of the present invention, there is provided a communication method between an electronic device system and another device, the electronic device system comprising an electronic device and an expansion device comprising a first communication device, the electronic device being connectable with the expansion device and comprising a second communication device, the method comprising detecting connection and disconnection between the expansion device and electronic device; communicating with another device by the first communication device when connection is detected, and by the second communication device when disconnection is detected.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a perspective view showing a docking state of a personal computer and a docking station according to a first embodiment of the present invention;

FIG. 2 shows a hardware configuration of the personal computer of the embodiment;

FIG. 3 shows a hardware configuration of the docking station of the embodiment;

FIG. 4 shows a system configuration of the personal computer and the docking station;

FIG. 5 shows a LAN communication between the personal computer and an access point station;

FIG. 6 shows a wireless communication between the personal computer and an access point station;

FIG. 7 shows a flowchart of communication switching operation at a time of undocking;

FIG. 8 shows a flowchart of communication switching operation at a time of docking; and

FIG. 9 shows a flowchart of communication switching operation at a time of undocking according to the second embodiment.

### DETAILED DESCRIPTION OF THE INVENTION

Embodiments of an electronic device, an electronic device system, and a communication method according to the present invention will now be described with reference to the accompanying drawings. In the present embodiments, although there is described switching between a wired communication and a wireless communication by way of exemplifying a computer system comprising a personal computer and a docking station, such description is provided as a mere example, and another device or another communication interface may be employed.

### FIRST EMBODIMENT

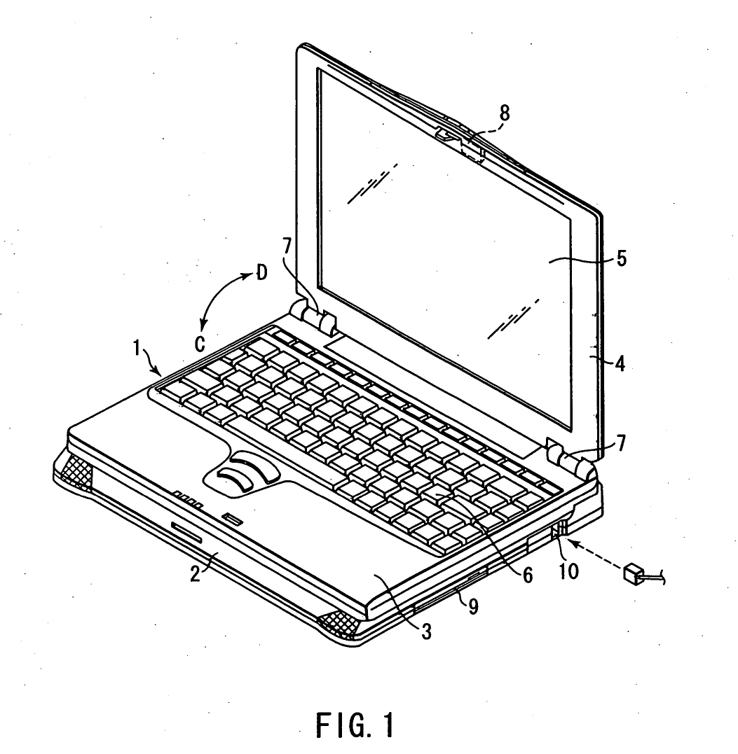

FIG. 1 is a perspective view showing an example when a personal computer 1 and a docking station 2 are connected with each other.

When the personal computer 1 is docked to the docking station 2, a communication between the personal computer 1 and an external device is made by a wired communication interface provided at the docking station 2. When the personal computer 1 is undocked from the docking station 2, a communication between the personal computer 1 and external device is made by a wireless communication interface provided at the personal computer 1.

The personal computer 1 has a main body case 3, a display portion case 4, an LCD panel 5, and a keyboard 6. The main body case 3 arranges the keyboard 6 at its top face portion. The display portion case 4 is turnably connected to the main body case 3 by hinge portions 7. The display portion case 4 maintains the periphery of the LCD panel 5 so that a display region of the LCD panel 5 is visible. The display portion case 4 is turnable in a direction indicated by the arrow C-D via the hinge portions 7, and is turnable between a closed position covering the keyboard 6 and an open position at which the keyboard 6 is available.

A wireless communication portion 8 is provided at the upper center of the display portion case 4. Here, “Bluetooth” is employed as an example of wireless communication system. “Bluetooth” is a short distance wireless communication system that achieves wireless communication within 10 meters by employing an ISM (Industry Science Medical)-band having its 2.4 GHz bandwidth. “Bluetooth” employs a frequency hopping system as a spread spectrum system, and up to eight terminals can be connected in a time division multiple system. A wireless communication portion 8 may be a wireless LAN system such as IEEE 802.11.

When the docking station 2 is connected to the personal computer 1, the docking station 2 expands functions of the personal computer 1, and provides them to a user. The docking station 2 has a CD-ROM drive 9 and a modular jack 10, etc. which are not included in the personal computer 1.

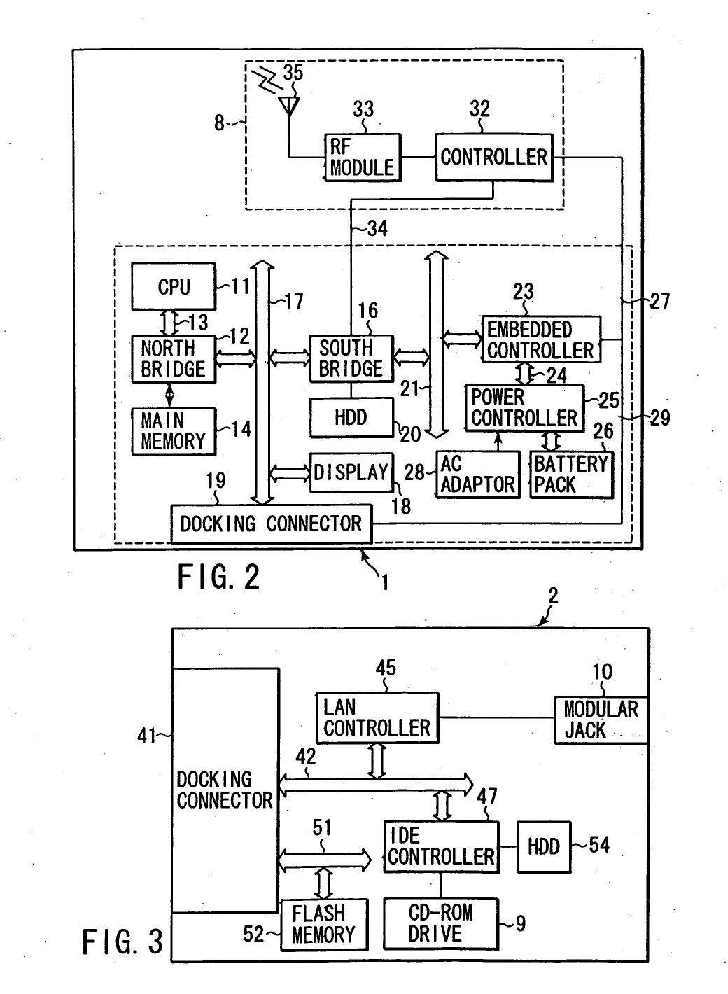

FIG. 2 shows a hardware configuration of the personal computer 1.

The personal computer 1 comprises devices required for such general personal computer to operate. A CPU 11 that governs the control of the personal computer 1 and a north bridge 12 are connected by a CPU local bus 13 having a 64-bit width data bus. In general, a connection between the north bridge 12 and a main memory 14 is made via a memory bus. However, in the present embodiment, this connection is made by utilizing a CPU local bus 13. The north bridge 12 and a south bridge 16 are connected to each other by a PCI (Peripheral Component Interconnect) bus 17 having a 32-bit width data bus. A display portion 18 and a docking connector 19 connected to the docking station 2 and comprising a plurality of signal pins are connected to the PCI bus 17. An HDD 20 is connected to the south bridge 16. An embedded controller 23 is connected via an ISA (Industry Standard Architecture) bus 21 having a 16-bit width data bus to the south bridge 16.

The CPU 11 executes operation control and data processing and the like of the entire personal computer 1.

The main memory 14 is a memory device that stores an operating system, a device driver, an application program targeted to be executed, and processing data, and comprises a plurality of DRAMs or the like.

The north bridge 12 is a bridge LSI that makes connection between the CPU local bus 13 and the PCI bus 17, and functions as one bus master device of the PCI bus 17. The north bridge 12 has a function for converting a width of a bus that contains data and an address between the CPU local bus 13 and the PCI bus 17, and a function for controlling an access of the main memory 14 via a memory bus.

The PCI bus 17 is a clock synchronization type input/output bus, and all the cycles over the PCI bus 17 are executed in synchronization with a PCI bus clock. The PCI bus 17 has an address/data bus used in a time division manner.

The display portion 18 is a device for visually displaying image data.

The south bridge 16 is a bridge LSI that makes a connection between the PCI bus 17 and the ISA bus 21. This bridge carries out bus conversion between the PCI bus 17 and the ISA bus 21. This bridge 16 incorporates an IDE (Integrated Device Electronics) controller for controlling the HDD 20 employed as a data storage/reproduction device and a USB (Universal Serial Bus) controller. The USB controller is provided to control serial data transfer. The HDD 20 is connected to the south bridge 16. The embedded controller 23 is connected to the ISA bus 21.

The embedded controller 23 is a bridge LSI that makes connection between the ISA bus 21 and an I²C bus 24. This controller 23 incorporate a plurality of registers capable of read/write operation by the CPU 11. Use of these registers enables communication between the CPU 11 and a device over the I²C bus 24. This controller 23 functions as a keyboard controller. Connection with the docking station 2 is detected by the embedded controller 23.

The I²C bus 24 is utilized for communication between the embedded controller 23 and a power controller 25 and between the power controller 23 and a battery pack 26. A connection is made between the embedded controller 23 and the wireless communication portion 8 by an I²C bus 27. A connection is made between the embedded controller 23 and the docking controller 19 by an I²C bus 29.

An AC adapter 28 for connecting a commercially available power source to the main body of the personal computer 1 is connected to the power controller 25. In this manner, the main body of the personal computer 1 can be powered from a commercially available power source via the AC adapter 28. The power controller 25 is a controller that controls an operating power source, e.g., turns on/off the power source of the personal computer 1. This controller 25 carries out charge control of a secondary battery of the battery pack 26.

The battery pack 26 is employed for backup in the case where power is not supplied from the AC adapter 28.

The wireless communication portion 8 controls wireless transmission and reception or the like, and has a controller 32, an RF module 33 and an antenna 35. These elements are connected via a specific bus.

The controller 32 carries out “Bluetooth” base band control (wireless interface control) for making “Bluetooth” wireless communication. This controller 32 serves as an interface portion that transmits/receives data via a USB bus 34 to/from the south bridge 16 or that transmits/receives a control signal to/from the embedded controller 23 both incorporated in the personal computer 1.

The RF module 33 is a module that carries out A/D conversion or D/A conversion of a signal in order to make radio data communication. This module 33 is connected to the antenna 35.

A hardware configuration of the docking station 2 will be described with reference to FIG. 3.

The docking station 2 has a docking connector 41 to be connected to the docking connector 19 of the personal computer 1. A PCI bus 42 is connected to the docking connector 41. A LAN controller 45 for controlling data communication with a wired network connected via a modular jack 10 and an IDE controller 47 for controlling a CD-ROM drive 9 or an HDD 54 are connected to the PCI bus 42.

An I²C bus 51 is connected to the docking connector 41, and a flash memory 52 is connected to the I²C bus 51.

The modular jack 10 connects a LAN cable, and makes available the personal computer 1 in wired network environment.

The LAN controller 45 is a controller that transmits/receives data via the modular jack 10. This controller 45 controls data communication in accordance with communication protocols.

The IDE controller 47 controls data communication with the CD-ROM drive 9 or HDD 54, and carries out control when data is transmitted onto the PCI bus 42 or when data transmitted via the PCI bus 42 is stored in the HDD 54.

The CD-ROM drive 9 reads data from a CD-ROM that is a storage medium, and transfers data to the IDE controller 47.

The HDD 54 is a data storage medium, and serves as an extended storage medium of the personal computer 1.

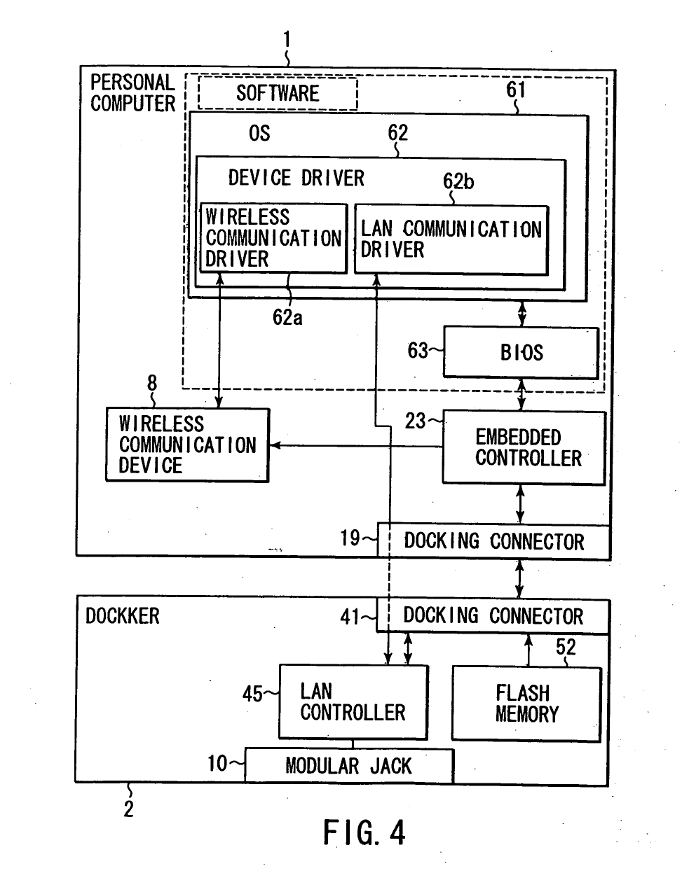

The flash memory 52 connected to the I²C bus 51 stores information on type of docking station 2 and device that the docking station 2 has. A system configuration of the personal computer 1 and the docking station 2 is shown in FIG. 4.

The personal computer 1 integrally manages and controls software and hardware operation by an OS 61. This OS 61 provides a device driver 62.

The device driver 62 is an interface program that enables each hardware component to be accessed from an application program. In the present embodiment, the device driver 62 comprises a wireless communication driver 62a and a wired communication driver 62b.

A BIOS 63 systematically provides a function execution routine for accessing a variety of system hardware components. The BIOS 63 judges an event signal from the embedded controller 23, and notifies docking or undocking to the OS 61. The BIOS 63 stores power saving settings such as whether or not to supply power to the wireless communication portion 8 or LAN controller 54.

A description of the wireless communication portion 8, embedded controller 23, LAN controller 45, modular jack 10, and flash memory 52 is omitted here because such description is identical to the above description regarding to FIGS. 2 and 3.

Now, a description will be given with respect to communication switching when the personal computer 1 is docked with the docking station 2 or undocked from the docking station 2.

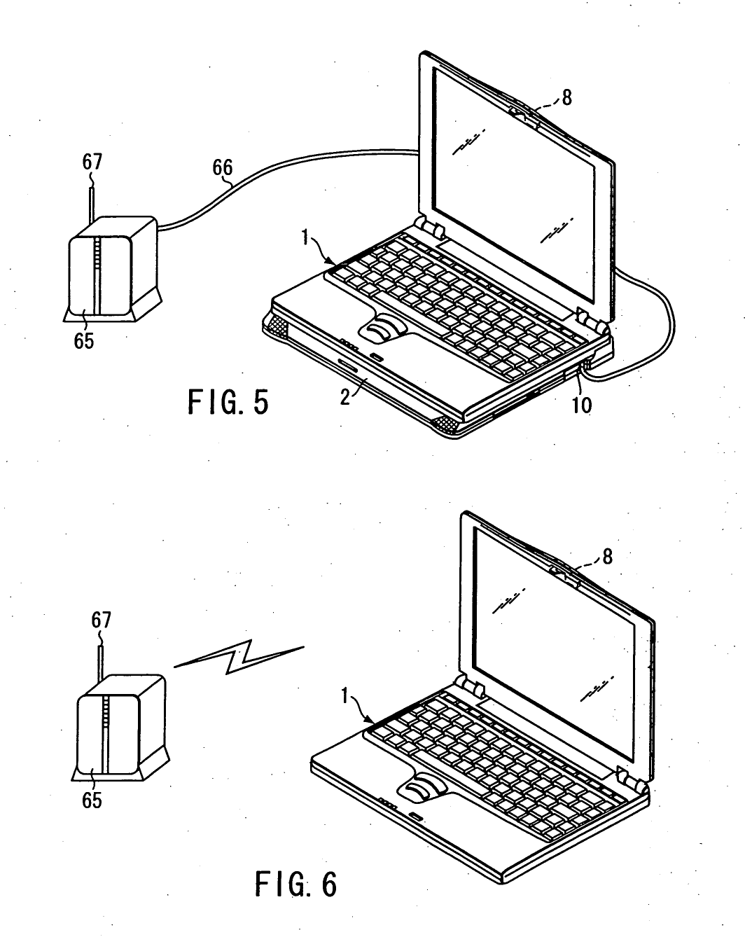

In the case where the personal computer 1 is docked with the docking station 2, the personal computer 1 is communicated with an access point station 65 via a LAN cable 66, as shown in FIG. 5.

The access point station 65 has a wired communication interface capable of making communication via a wired LAN and a wireless communication interface capable of making wireless communication with the wireless communication portion 8 that the personal computer 1 has. This access point station further has an antenna 67 for wireless communication and a LAN cable modular jack (not shown).

The personal computer 1 is capable of making communication with another personal computer as well as the access point station 65.

In the case where the personal computer 1 is undocked from the docking station 2, a data communication is made by wireless communication, as shown in FIG. 6. In this case, wireless communication is made between the wireless communication portion 8 that the personal computer 1 has and a wireless communication interface that the access point station 65 has.

In this case as well, the personal computer 1 is capable of making communication with another personal computer as well as the access point station 65.

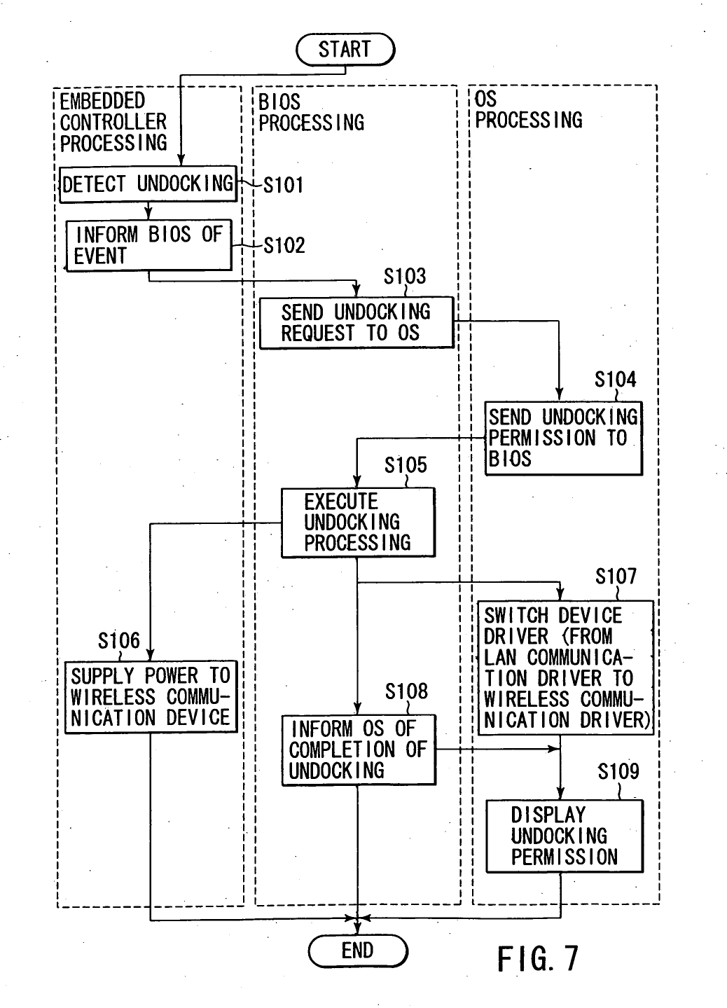

Now, an operation for switching a communication interface when the personal computer 1 is undocked from the docking station 2 will be described with reference to FIGS. 4 and 7.

When the personal computer 1 is undocked from the docking station 2, the embedded controller 23 incorporated in the personal computer 1 detects an undocking detection signal, and detects that they are disconnected (step S101).

The embedded controller 23 issues an event to the BIOS 63, and notifies that undocking has occurred (step S102).

The BIOS 63 issues an undock request to the OS 61 after confirming the contents of such an event (step S103).

The OS 61 notifies a permission for undock processing to the BIOS 63 upon the receipt of such an undock request from the BIOS 63 (step S104).

The BIOS 63 which has receives a permission for undock processing carries out undock processing for each device (step S105). At this time, the LAN controller 45 incorporated in the docking station 2 is set to a disable state and wired LAN environment is disabled. Then, a command is issued to the embedded controller 23 so as to supply power to the wireless communication portion 8, and enables wireless LAN environment.

The embedded controller 23 which has received a power supply command for the wireless communication portion 8 supplies power to the wireless communication portion 8 (step S106).

The BIOS 63 issues to the OS 61 a notification that the wired communication driver 62b (network device driver 62) is switched to the wireless communication driver 62a. The OS 61 switches the network device driver from the wired communication driver 62b to the wireless communication driver 62a according to such notification (step S107). Then, the BIOS 63 notifies to the OS 61 that an undocking process has been completed (step S108).

When the OS 61 determines that the wireless communication driver 62a is set as the device driver 62 upon the receipt of notification, and instructs the display portion 18 to display an undocking permission (step S109).

As has been described above, when the personal computer 1 is undocked from the docking station 2, processing for disabling a wired communication interface that the docking station 2 has is carried out. At the same time, processing for enabling the wireless communication portion 8 that the personal computer 1 has is carried out, making it possible for the personal computer 1 to carry out wireless communication.

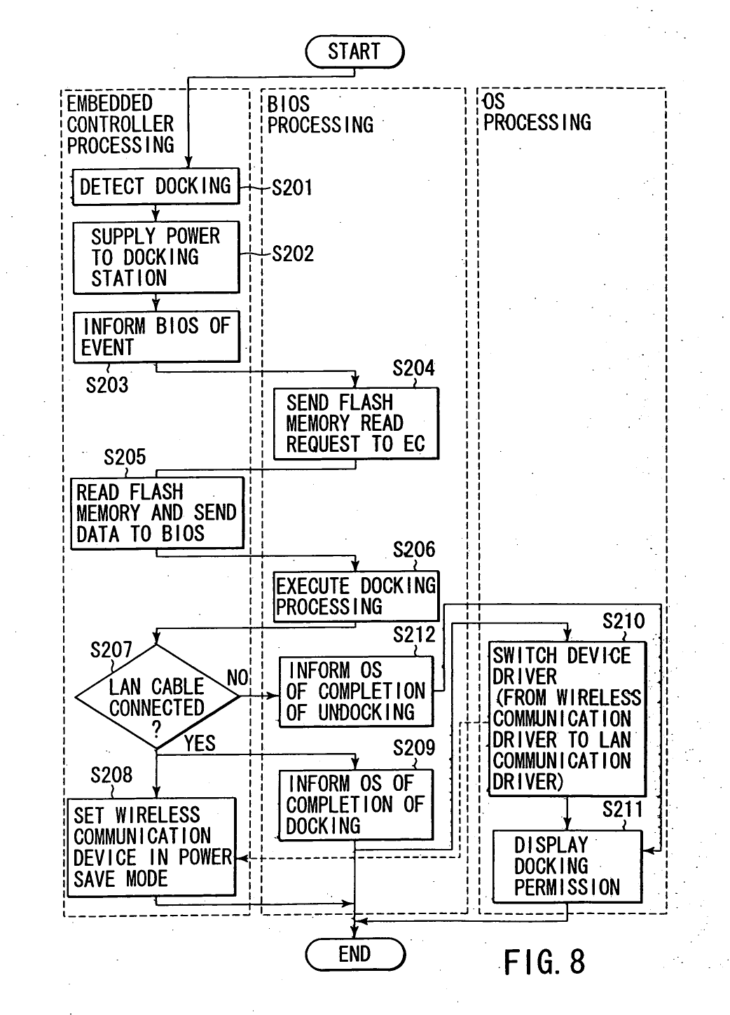

Now, switching a communication interface when the personal computer 1 is docked with the docking station 2 will be described with reference to FIGS. 4 and 8.

In the case where the personal computer 1 is docked with the docking station 2, the embedded controller 23 of the personal computer 1 detects a docking detection signal, and detects that the docking station 2 has been connected (step S201).

Then, the embedded controller 23 supplies power to the docking station 2 via the docking connector 19 (step S202), issues an event to the BIOS 63, and notifies that docking has occurred (step S203).

After determining the contents of such event, the BIOS 63 issues a data read instruction of the flash memory 52 to the embedded controller 23 in order to acquire information on a device that the docking station has from the flash memory 52 incorporated in the docking station 2 (step S204).

The embedded controller 23 reads device data from the flash memory 52 via the I²C bus 29 and the docking connector 19, and notifies the data to the BIOS 63 (step S205).

The BIOS 63 acquires device information on the docking station 2, and determines what device is connected to the docking station 2. The BIOS 63 supplies power to each device connected to the docking station 2, and carries out docking processing (step S206). At this time, initialization of the LAN controller 45 or IDE controller 47 is carried out, and is enabled.

Then, it is determined by a power output of the modular jack 10 whether or not a LAN cable is connected to the modular jack 10 (step S207).

At step S207, if it is determined that the LAN cable is connected (YES at step S207), the embedded controller 23 causes the wireless communication portion 8 to enter a power saving mode (step S208). Here, entering power saving mode is realized by setting of the BIOS 63, and a mode for supplying minimum power in order to receive radio data or a mode for completely disabling power supply or the like is set by the BIOS 63.

In addition, the BIOS 63 notifies docking to the OS 61 (step S209).

The OS 61 switches the wireless communication driver 62a (network device driver) to the wired communication driver 62b (step S210).

Then, the OS 61 causes the display portion 18 to display a docking permission (step S211).

At step S207, if no LAN cable connection is detected (NO at step S207), wired communication is disabled. Thus, the wireless communication portion 8 is kept being used as a communication interface.

Thus, the BIOS 63 notifies a docking to the OS 61 (step S212), and the OS 61 causes the display portion 18 to display a docking permission (step S211).

During the above described processing, although power saving settings to the wireless communication portion 8 have been provided by way of an instruction from the BIOS 63, it is also possible to manage power saving of the wireless communication portion 8 by the device driver 62 from the OS 61.

When the personal computer 1 is docked with the docking station 2 by way of the above described processing, a wireless communication is switched to a wired communication, making it possible to save power supply to the wireless communication portion 8 consumed by the personal computer 1.

As has been described above, according to the present embodiment, in a system including a personal computer and a docking station to which the personal computer is removably connected, the personal computer comprises a first communication interface that makes wireless communication with an external device and a detecting portion for detecting connection with the docking station. The docking station comprises a second communication interface that makes wired communication with an external device. The personal computer further comprises a control portion. If the detecting portion detects connection with the personal computer and the docking station, the control portion sets the system configuration so as to make communication with an external device via the second communication interface, and sets the system configuration so as to make communication with an external device via the first communication interface. It is not necessary to restart a personal computer every time the system configuration is set. This makes it possible to automatically switch a communication interface that a personal computer and a docking station have according to a state of docking/undocking between the personal computer and the docking station.

### SECOND EMBODIMENT

The first embodiment has described that undock processing is primarily carried out by the OS 61. Now, a second embodiment in which undock processing is primarily carried out by the BIOS 63 will be described here.

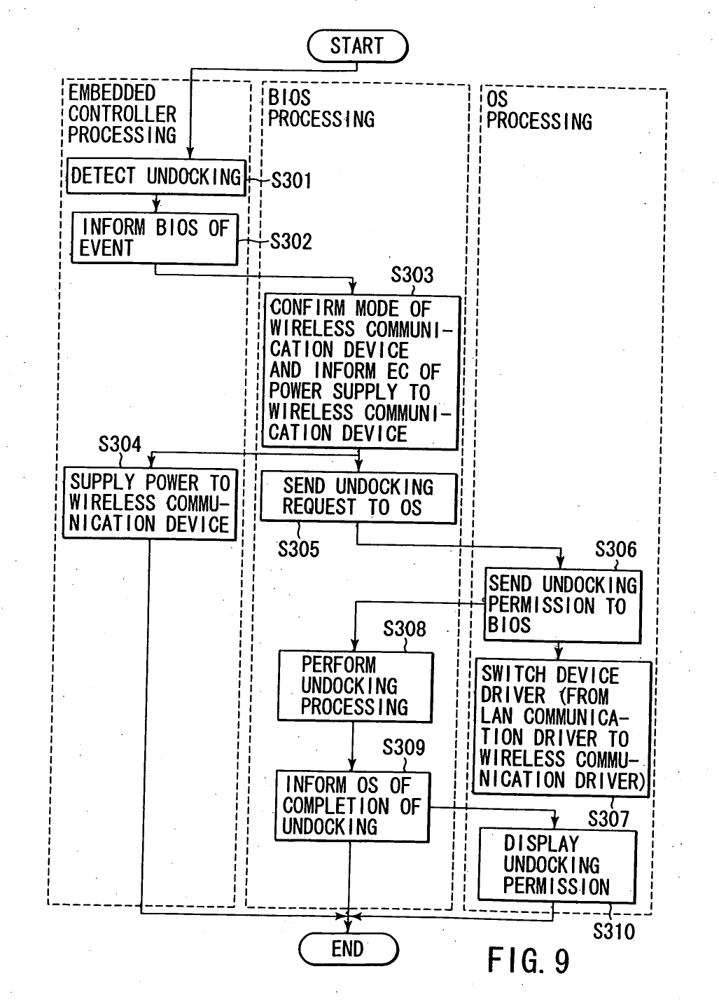

The personal computer 1 and the docking station 2 have the same elements as described above. A description of these elements is omitted here. A communication interface switching operation when the personal computer 1 is undocked from the docking station 2 will be described with reference to FIGS. 4 and 9.

When the personal computer 1 is undocked from the docking station 2, the embedded controller 23 detects a docking detection signal, and detects that the personal computer 1 is undocked from the docking station 2 (step S301).

Then, the embedded controller 23 issues an event to the BIOS 63, and notifies that undocking has occurred (step S302).

The BIOS 63 determines power saving settings of the wireless communication portion 8 after determining the contents of such event. Then, the BIOS 63 instructs to the embedded controller 23 power supply to the wireless-communication portion 8 (step S303). However, the settings at the BIOS 63 not only instructs power supply to the wireless communication portion 8, but also disabling power supply to the wireless communication portion 8 even if undocking occurs. In the present embodiment, an example in which power is supplied to the wireless communication portion 8 if undocking occurs will be described.

The embedded controller 23 supplies power to the wireless communication portion 8 according to an instruction from the BIOS 63 (step S304).

The BIOS 63 issues an undock request to the OS 61 (step S305).

The OS 61 notifies a permission for undock processing to the BIOS 63 upon the receipt of the undock request from the BIOS 63 (step S306). Then, the OS 61 switches the wired communication driver 62b to the wireless communication driver 62a (step S307).

The BIOS 63 which has received the permission for undock processing carries out undock processing for each device (step S308). At this time, the LAN controller 45 incorporated in the docking station 2 is set to a disable state, and wired LAN environment is disabled.

Then, the BIOS 63 notifies to the OS 61 that an undocking process has been completed (step S309).

The OS 61 determines that the wireless communication driver 62a is set to the device driver upon the reception of the notification, and instructs the display portion 18 to display undocking process (step S310).

As has been described above, in the second embodiment as well, when the personal computer 1 is undocked from the docking station 2, processing for disabling the wireless communication portion 8 is carried out, disabling a function that the docking station has.

The present invention can be variously modified and embodied without being limited to the above described embodiments. For example, although in the above embodiments the personal computer 1 has a wireless communication interface, and the docking station 2 has a wired communication interface, the present invention is not limited to this case at all. For example, the present invention is applicable to a personal computer 1 having a wired communication interface or a docking station 2 has a wireless communication interface, or alternatively, the personal computer 1 and docking stations 2 each having a wireless communication interface. In this case, it is assumed that the docking station 2 is always installed at home or at office. Thus, a wireless communication interface that the docking station 2 comprises is always set to an enable state. The wired communication interface may be connected via a general telephone line as well as LAN or may be connected by employing a fast wired communication (xDSL) such as ADSL.

Referring to FIGS. 7 to 9, a description has been given by exemplifying an OS which incorporates only one network device, for example, “Windows 98”. Thus, a device driver is switched at steps S107 and S210. However, in the case of an OS which can incorporate a plurality of networks simultaneously, for example, “Windows 2000”, the only thing to do is to selectively enable a device driver instead of switching the device driver.

In addition, during wired communication, in order to save power and prevent peripheral electric wave interference, it is possible to turn off the power source of the wireless communication portion 8 (in the above described embodiment, a power saving mode is merely set). When undocking occurs, the power source of the wireless communication portion 8 is turned on, thereby making it possible to save power of the personal computer 1.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents. For example, the present invention can be embodied as a communication method or a computer readable recording medium having recorded therein a program for causing a computer to execute the above communication method.

As has been described above, according to the present invention, there can be provided an electronic device system and a communication interface switching method capable of automatically switching a communication interface according to a state change, i.e., whether a personal computer and a docking station are docked with or undocked from each other.

1. An electronic apparatus system comprising:
an expansion unit comprising a first communication device for communicating with an external device based on a first communication system; and
an electronic apparatus which is connectable with said expansion unit and comprises a second communication device for communicating with the external device based on a second communication system, a detector configured to detect connection with and disconnection from said expansion unit, and a communication controller configured to be able to communicate with the external device by said first communication device when said detector detects connection with said expansion unit, and communicate with the external device by said second communication device when said detector detects disconnection from said expansion unit.

2. The system according to claim 1, wherein
said expansion unit comprises a first connection device;
said electronic apparatus comprises a second connection device which is connected to the first connection device; and
said detector comprises a detecting section configured to detect connection and disconnection between said first and second connection devices.

3. The system according to claim 1, wherein said electronic apparatus comprises a power controller configured to stop power supply to said second communication device when said detector detects connection with said expansion unit, and to supply power to said second communication device when said detector detects disconnection from said expansion unit.

4. The system according to claim 3, wherein said power controller supplies power to said expansion unit when said detector detects connection with said expansion unit.

5. The system according to claim 4, wherein said power controller supplies power to said first communication device when said detector detects connection with said expansion unit.

6. The system according to claim 1, wherein said first communication device comprises a wired communication device and said second communication device comprises a wireless communication device.

7. The system according to claim 6, wherein said electronic apparatus comprises a power controller configured to stop power supply to said second communication device when said detector detects connection with said expansion unit, and to supply power to said second communication device when said detector detects disconnection from said expansion unit.

8. The system according to claim 7, wherein said power controller supplies power to said expansion unit when said detector detects connection with said expansion unit.

9. The system according to claim 8, wherein said power controller supplies power to said first communication device when said detector detects connection with said expansion unit.

10. The system according to claim 1, wherein said electronic apparatus comprising a notebook type personal computer and said expansion unit comprises a function expansion device comprising a unit which is not included in said laptop personal computer.

11. An electronic apparatus which is connectable with an expansion unit for providing a device which is not provided in the electronic apparatus, the expansion unit comprising a first communication device for communicating with an external device based on a first communication system, the electronic apparatus comprising:
a second communication device for communicating with the external device based on a second communication system;
a detector configured to detect connection with and disconnection from said expansion unit; and
a communication controller configured to be able to communicate with the external device by said first communication device when said detector detects connection with said expansion unit, and communicate with the external device by said second communication device when said detector detects disconnection from said expansion unit.

12. The apparatus according to claim 11, further comprising a power controller configured to stop power supply to said second communication device when said detector detects connection with said expansion unit, and to supply power to said second communication device when said detector detects disconnection from said expansion unit.

13. The apparatus according to claim 12, wherein said power controller supplies power to said expansion unit when said detector detects connection with said expansion unit.

14. The according to claim 13, wherein said power controller supplies power to said first communication device when said detector detects connection with said expansion unit.

15. The apparatus according to claim 11, wherein said first communication device comprises a wired communication device and said second communication device comprises a wireless communication device.

16. The apparatus according to claim 11, wherein said communication controller comprises a device driver to which one of said first communication device and second communication device is selectively installed based on a detection result of said detector.

17. The apparatus according to claim 11, wherein said communication controller comprises a first device driver to which said first communication device is installed, a second device driver to which said second communication device is installed, and a selector configured to select one of said first and second device drivers based on a detection result of said detector.

18. A communication method between an electronic apparatus system and an external device, the electronic apparatus system comprising an electronic apparatus and an expansion unit comprising a first communication device for communicating with the external device based on a first communication system, the electronic apparatus being connectable with said expansion unit and comprising a second communication device for communicating with the external device based on a second communication system, the method comprising:
detecting connection and disconnection between said expansion unit and electronic apparatus;
communicating with the external device by said first communication device when connection is detected, and by said second communication device when disconnection is detected.

19. The method according to claim 18, wherein said first communication device comprises a wired communication device and said second communication device comprises a wireless communication device.

20. The method according to claim 18, further comprising:
stopping power supply to said second communication device when said detector detects connection with said expansion unit; and
supplying power to said second communication device when said detector detects disconnection from said expansion unit.

21. The method according to claim 18, further comprising
supplying power to said expansion unit when said detector detects connection with said expansion unit.

22. The method according to claim 21, wherein said supplying comprising supplying power to said first communication device when said detector detects connection with said expansion unit.
